(19) United States
(12) Patent Application Publication
(10) Pub. No.: US 2002/0032618 A1
(43) Pub. Date: Mar. 14, 2002

(54) Information disclosing control method and its system, and computer program

(75) Inventors: Katsutoshi Nakamura, Tokyo (JP); Yoko Takei, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Seiko Epson Corporation, Shinjuku-ku (JP)

(21) Appl. No.: 09/942,620

(22) Filed: Aug. 31, 2001

(30) Foreign Application Priority Data
Aug. 31, 2000 (JP) 2000-262908
Aug. 30, 2001 (JP) 2001-261953
Aug. 31, 2001 (JP) 2001-265005

(51) Int. Cl. G06F 15/16; G06F 17/60

(52) U.S. Cl. 705/26; 709/206

(57) ABSTRACT

A service operation system has an electronic bulletin board to which a sales shop apparatus, which sales a predetermined product and the other product relevant to the predetermined product, can gain access via the Internet in connection with product information relevant to other product. A server receives registration of product information and the edition from a service support system. Before registered or edited product information is disclosed on the electronic bulletin board, a main controller receives approval of this product information from a terminal that is operated by a predetermined manager. Also, the main controller limits the disclosing of the registered or edited product information.

### CROSS-REFERENCE TO RELATED APPLICATIONS

This application is based upon and claims the benefit of priority from the prior Japanese Patent Applications Nos. 2000-262908, filed Aug. 31, 2000, 2001-261953 filed Aug. 30, 2001, and 2001-265005 filed Aug. 31, 2001, the entire contents of all of which are incorporated herein by reference.

### BACKGROUND OF THE INVENTION

1. Field of the Invention

The present invention relates to an information providing method for providing information relevant to a predetermined subject such as information relevant to products over a wide-area network such as Internet to a specific person. More specifically, the present invention relates to a mechanism for performing information providing work appropriately and efficiently.

2. Description of the Related Art

There has been conventionally performed service for providing various kinds of information to numerous persons from a certain person over the Internet. Such service exists in a wide variety of forms. One of the most frequently used is an electronic bulletin board in which a service operator opens a homepage and permits indefinite persons to disclose (post) information on the homepage freely and to update information. It is assumed that this is a first form.

There is another form in which the service operator invites general persons to post information on the homepage widely and processes various kinds of collected information and the operator posts them on the homepage. It is assumed that this is a second form.

Moreover, in recent years, there is another method in which a certain service operator sets up a homepage with a specific purpose and permits specific persons, who support this purpose, to write thereon. It is assumed that this is a third form. In the case of third form, it is general that the service operator selects the persons, who are permitted to write thereon, in advance.

In connection with the first form, since various kinds of information are posted on the homepage regardless of the service operator's intension, there is a possibility that information disadvantageous to the service operator is directly posted on the homepage or the contents legally prohibited will be posted thereon and opened.

In connection with the second form, processing of obtained information and processing relevant to the placement of information on the homepage are all performed on the service operator side. For this reason, in the case where the registration of information, the update, and the deletion are frequently performed, the burdens on the service operator are increased.

In connection with the third form, though the service operator selects the specific persons, who are permitted to write thereon, in advance, the service operator does not restrain what contents of information are written by the specific persons. For this reason, the same problem as that of the first form occurs in some cases.

In any case, when the service operator permits the plurality of persons to post information on an electronic bulletin board, any one of problems always occurs.

### SUMMARY OF THE INVENTION

It is an object of the present invention is to provide a method capable of controlling information disclosing form on an electronic bulletin board appropriately and efficiently when information relevant to a predetermined subject such as product information relevant to products is disclosed on the electronic bulletin board.

According to an aspect of the invention, there is provided a method executed in an apparatus to which at least one terminal is capable of accessing via a network, comprising the steps of. forming an electronic bulletin board for disclosing product information relevant to a product to be readable via said network from a terminal that is operated by a salesperson who sells said product; receiving a request to register or change said product information, which is sent from a terminal that is operated by a person who wishes to disclose information on said electronic bulletin board via said network; and limiting the disclosing of product information, which is pursuant to the request, until approval of the received request is obtained from an information manager.

Additionally, the information manager includes a manager who manages the electronic bulletin board, a manufacturer who manufactures a predetermined product, or a person who is entrusted with the management of disclosing information by the manager or the manufacturer. Moreover, the changing of product information is a concept including the correction and deletion of a part or an entirety of product information already disclosed on the electronic bulletin board. The product information includes customer service information such as product maintenance information.

The limitation of information disclosure of the present invention may be implemented not only by limiting for posting information on the electronic bulletin board but by limiting for accessing to information which has been posted on the electronic bulletin board.

The limiting step may comprise a substep of replacing an entirety or a part of the requested product information with other disclosing information to be disclosed on the electronic bulletin board until approval of the received request is obtained from the information manager. Or, the limiting step may comprise a substep of preregistering introduction information for introducing the person who wishes to disclose information in the a preset recording area, and disclosing the introduction information on the electronic bulletin board until approval is obtained from the information manager. In connection with introduction information, the method can further comprise the step of preregistering introduction information for introducing the person who wishes to disclose information in the preset recording area, and disclosing the introduction information on the electronic bulletin board with product information, which is pursuant to the request, on the precondition that approval is obtained from the information manager.

Additionally, when the person who wishes to disclose information is a company such a manufacturer, introduction information is a concept including information such as a name of company, address, key contact address to explain the company.

In terms of restraining the disclosing of disorderly information, it is possible to limit the person who wishes to disclose information to a certain degree. For example, the request receiving step may comprise a substep of informing the person who wishes to disclose information of identifying information for identifying the person and receiving only the request with the identifying information.

Moreover, for the convenience of the registration of product information or the work to request the correction, the method may further comprise the step of presenting an input screen page for urging registration or change of product information to the terminal that is operated by the person who requests the disclosing of information on the electronic bulletin board, whereby constructing an environment in which the person who wishes to disclose information is capable of making the request through the input screen page. In this case, the product information is classified into a plurality of groups, and the presenting step comprises a substep of presenting classification items for specifying the information groups on the input screen page, whereby making it possible for the person who wishes to disclose information to select a desired information group through the classification items on the input screen page and to make the request.

Furthermore, the information manager is fixed for each classification item, the request receiving step comprises a substep of, when the request of an arbitrary classification item is made, recognizing the request by the information manager corresponding to the classification item, and the limiting step comprises a substep of receiving approval or disapproval that the corresponding information manager issues after checking the request. This makes it possible to distribute the work, which is required to store information and read information, and to improve the efficiency of the work.

The limiting step may comprise a substep of receiving approval or disapproval that the corresponding information manager issues after checking the request, and sending the received approval or disapproval via the network to the terminal that is operated by a person who wishes to disclose information on the electronic bulletin board. In this case, the person who wishes to disclose information can readily confirm whether or not the request is approved.

According to another aspect of the present invention, there is provided a method executed in an apparatus having a logical space to which at least one terminal is capable of accessing via a network, comprising the steps of: forming an electronic bulletin board for disclosing product information of a predetermined product and/or other products relevant to the predetermined product in the logical space to a salesperson who sells at least one of the predetermined product and other products; receiving a request to register or change the product information from a terminal that is operated by a person who wishes to disclose information on the electronic bulletin board via the network; and limiting the disclosing of product information, which is pursuant to the request, until approval of the received request is obtained from an information manager.

According to another aspect of the present invention, there is provided a method executed in an apparatus having a logical space to which at least one terminal is capable of accessing via a network, comprising the steps of: forming an electronic bulletin board for disclosing information relevant to a predetermined subject in the logical space to be readable via the network from a terminal that is operated by a user who uses the predetermined subject; receiving a request to register or change information relevant to the predetermined subject from a terminal that is operated by a person who wishes to disclose information on the electronic bulletin board via the network; and limiting the disclosing of product information, which is pursuant to the request, until approval of the received request is obtained from an information manager.

According to another aspect of the present invention, there is provided a system comprising: means for forming an electronic bulletin board for disclosing information in a logical space to which at least one terminal is capable of accessing via a network; means for receiving a request to register or change object information from a terminal that is operated by a person who wishes to disclose information on the electronic bulletin board via the network; and means for limiting the disclosing of object information, which is pursuant to the request, until approval of the received request is obtained from an information manager. The electronic bulletin board may include an area for providing product information relevant to a product to a salesperson who wishes to sell the product, and the receiving means receives the request to register or change object information relevant to the product.

According to another aspect of the present invention, there is provided a computer program for rendering a computer to serve as a information disclosing support system connecting with a network, the system comprises: a function of forming an electronic bulletin board for disclosing information in a logical space to which at least one terminal is capable of accessing via a network; a function of receiving a request to register or change object information from a terminal that is operated by a person who wishes to disclose information on the electronic bulletin board via the network; and a function of limiting the disclosing of object information, which is pursuant to the request, until approval of the received request is obtained from an information manager. The computer program may be stored in a computer readable storage medium.

### BRIEF DESCRIPTION OF THE DRAWINGS

These objects and other objects and advantages of the present invention will become more apparent upon reading of the following detailed description and the accompanying drawings in which:

FIG. 1 is a block diagram illustrating the entirety of the configuration of an embodiment in which the present invention is applied to a dealership system;

FIG. 2 is a view explaining service provision processing of the present dealership system in connection with each of a service operation system, a service support system, and a sales shop apparatus;

FIG. 3 is an example of a screen page, which is displayed when the service support system gains access to a server;

FIG. 4 is an example of a screen page, which is displayed when the service supporter registers the service supporter's information using the service support system;

FIG. 5 is an example of a screen page, which is displayed when the service supporter registers the service supporter's information using the service support system;

FIG. 6 is an example of a screen page, which is displayed when the service supporter registers product information using the service support system;

FIG. 7 is an example of a screen page, which is displayed when the service supporter registers product information using the service support system;

FIG. 8 is an example of a screen page, which is displayed on a terminal that a manager operates;

FIG. 9 is an example of a screen page to display product information, of which the manager is in charge, at the terminal that the manager operates;

FIG. 10 is an example of a screen page to display to perform determination whether or not product information should be approved at the terminal that the manager operates;

FIG. 11 is an example of a screen page, which is displayed when the sales shop apparatus searches product information;

FIG. 12 is an example of a screen page on which the result of searched and required product information is displayed at the sales shop apparatus; and

FIG. 13 is an example of a screen page oh which product information is displayed specified by a sales person at the sales shop apparatus.

### DETAILED DESCRIPTION OF THE PREFERRED EMBODIMENT

An embodiment of the present invention will be specifically described with reference to the drawings accompanying herewith.

The following will explain an embodiment of the present invention based on a case in which the present invention is applied to information providing service system (dealership system) wherein a salesperson, who deals with a certain product and the other product relevant to the product, is an information providing person. In this embodiment, the product refers to electronic devices (hereinafter referred to as “ED”) such as various kinds of printers, scanners, digital cameras, portable terminals and the like. The other product refers to an application program and peripheral devices (hereinafter referred to as “AP”). For example, in the case where ED is a portable terminal, AP refers to a plurality of application programs that work on this portable terminal. It is noted that they are no more than an example.

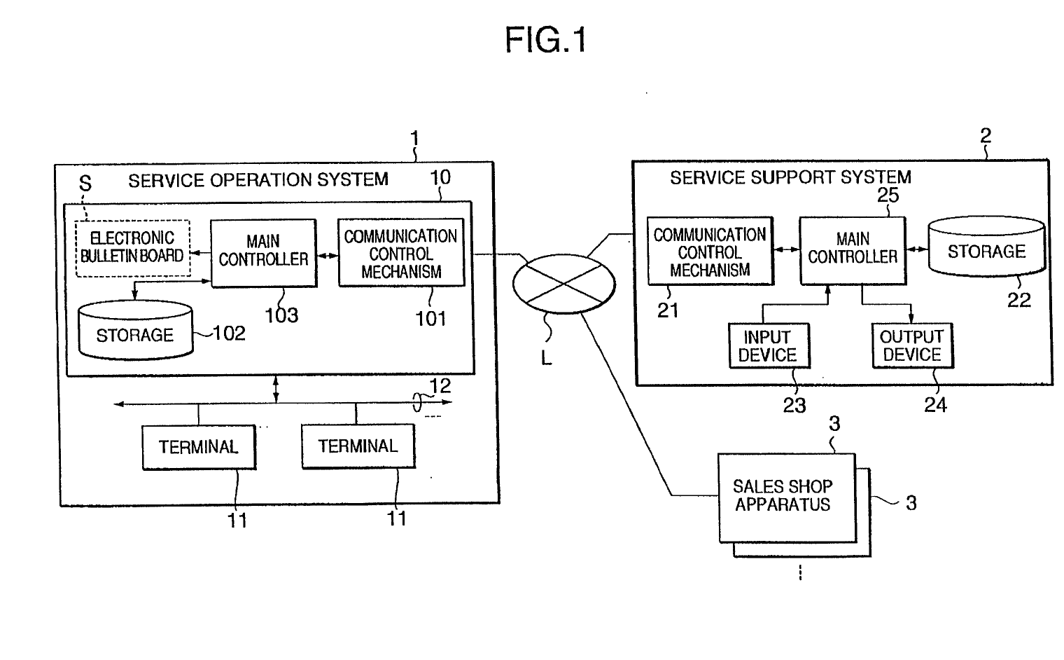

In the dealership system of this embodiment, as illustrated in FIG. 1, a service operation system 1, one or a plurality of service support system 2, and a plurality of sales shop apparatuses 3 are connected to one another in such a manner that two-way communication is can be performed via the Internet L.

<Service Operation System>

The service operation system 1 is one of computer systems where a server 10 and a plurality of terminals 11 are connected to each other via a LAN. The service operation system forms an electronic bulletin board S on a logical space to which the service support system 2 and the sales shop apparatus 3 can gain access, and operates service for introducing product information, which the system deal with, and product information relevant to AP and peripheral devices via this electronic bulletin board S.

The server 10 is composed of a communication control mechanism 101 such as a TA (Terminal adapter) for establishing a communication channel with the Internet L, storage 102 such as a hard disk and the like, and a main controller 103 including a CPU (Central Processing Unit) board. The terminals 11 are general-purpose computers that can perform transmission and reception to/from the server 10.

The electronic bulletin board S is, e.g., a homepage that is allowed to be browsed by only an approved person, a formed space in a logical space, or a formed area (filed) in a predetermined memory.

In the server 10, the communication control mechanism 101 receives the writing of product information to the electronic bulletin board S and the browsing and sends the reception result. Control of the writing of product information to the electronic bulletin board S and the browsing is exercised when the main controller 103 reads a program code and digital data recorded on storage 102 and executes it.

<Service Support System>

The service support system 2 is a computer or a computer system, and is used to disclose (post) product information of AP on to the electronic bulletin board S formed in the service operation system 1. The service support 2 is composed of a communication control mechanism 21 such as a TA (Terminal adapter) for establishing a communication channel with the Internet L, storage 22 such as a hard disk and the like on which contents for expressing specific contents of product information are recorded, an input device 23 for inputting product information to be desirably posted (disclosed) on the electronic bulletin board S, an output device 24 for outputting various kinds of information obtained by the electronic bulletin board S and other information, and a main controller 25 including a board. The output device 24 includes a printer, a recording deice to information recording media such as an MD, a DVD and the like, a display device, and so on. The function of the main controller 25 will be described later.

<Sales Shop Apparatus>

The sales shop apparatus 3 is used to access the electronic bulletin board S of the service operation system 1 and to browse product information of AP, including the relationship of AP in connection with ED, and information of a manufacturer or a salesperson of AP, and is a general-purpose computer equipped with a browser such as Internet Explorer (trademark of Microsoft Co. Ltd.)

<Operation Form>

An explanation will be given of an example of the operation form of the above-configured dealership system.

In the dealership system, the service operator (a person who operates the service operation system 1) and the service supporter (a person who operates the service support system 2) post product information on the electronic bulletin board S and provide information to the sales person (person who operates the sales shop apparatus 3) in teamwork with each other. The service operator side adds a fixed limitation to posting information offered by the service supporter. The service operator corresponds to the manufacturer who products ED and a person who provides ED to the salesperson from the manufacturer. A manager, who judges whether or not the fixed limitation should be applied to posting information, is decoded on a category-by-category basis in connection with ED. The service supporter corresponds to the manufacturer of AP and a person who provides AP to the salesperson.

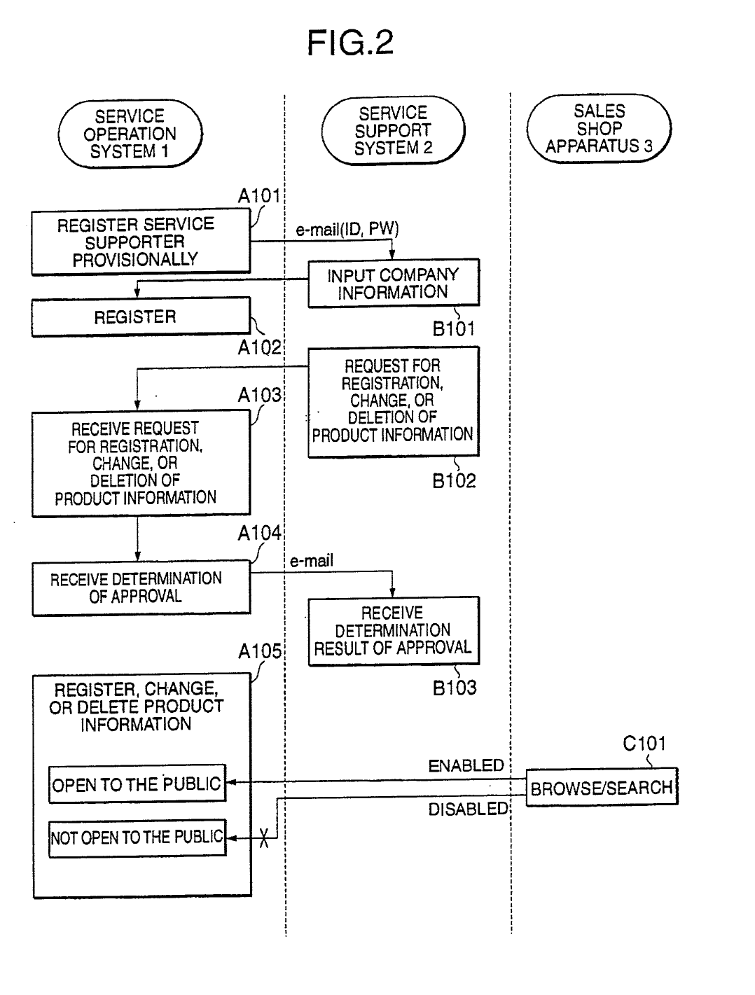

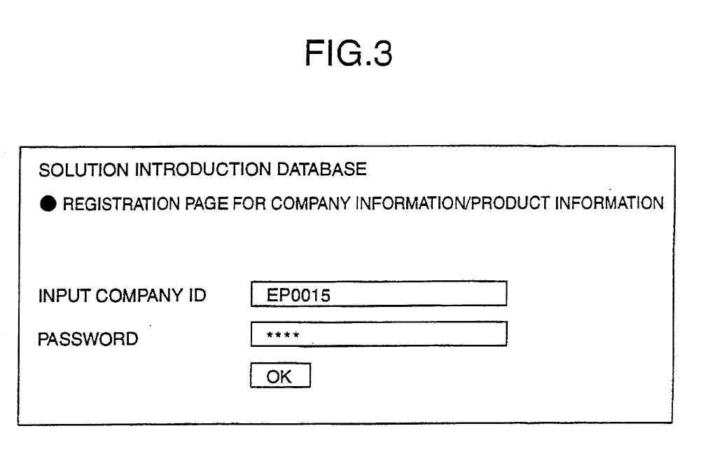

FIG. 2 is a view explaining service provision processing of the present dealership system in connection with each of the service operation system 1, the service support system 2, and the sales shop apparatus 3 and the relationship among them according to this operation forms. The following will explain each processing with reference to this figure. Moreover, FIGS. 3 to 13 used in this case are examples of screen pages that urge the operator of the system to input the operation and send the notification of a processing result.

<Provisional Registration Processing A101 >

At the time of operating the dealership system, it is assumed that the service operator obtains a name and an address name of the service supporter in advance.

This processing is allowed by the past business history done between the service operation side dealing with ED and the service supporter dealing with AP relevant to ED. A new service supporter may operate its service support system to notify the service operator of the fact that the new service supporter desires to register as a service supporter offline or using e-mail.

The service operator operates the terminal 11 to input the name and e-mail address of the service supporter. The terminal 11 notifies the server 10 of inputted information.

The main controller 103 of the server 10 sets identification (ID) information uniquely allocated to the registering service supporter and a password (PW) to gain access to the server 10. The main controller 103 registers the set ID and PW to the storage 102 with the name and e-mal address. The main controller 103 sends the e-mail to which ID and PW are written to the e-mail address of the registering service supporter via the communication control mechanism 101.

Thus, the name of the registering service supporter, e-mail address, ID, and PW are registered in the storage 102. Moreover, ID and PW, which are necessary to gain access to the server 10, are sent to the service supporter using e-mail.

<Input of Company Information B101>

The service supporter that operates the service support system confirms e-mail directed to its own address, with result that the service support can gain assess to the server 10 using ID and PW described in e-mail. For example, in the case where the service supporter registers information of the service supporter (hereinafter referred to as “company information”), the communication control mechanism 21 sends an access request inputted via the input device 23 to the server 10. The server 10 sends information for displaying a login screen page as illustrated in FIG. 3 on the output device 24 is sent from the server 10. When ID and PW inputted in accordance with the login screen page in the service support system 2 are correct, access to the server 10 is permitted. When ID and PW are incorrect, access is rejected.

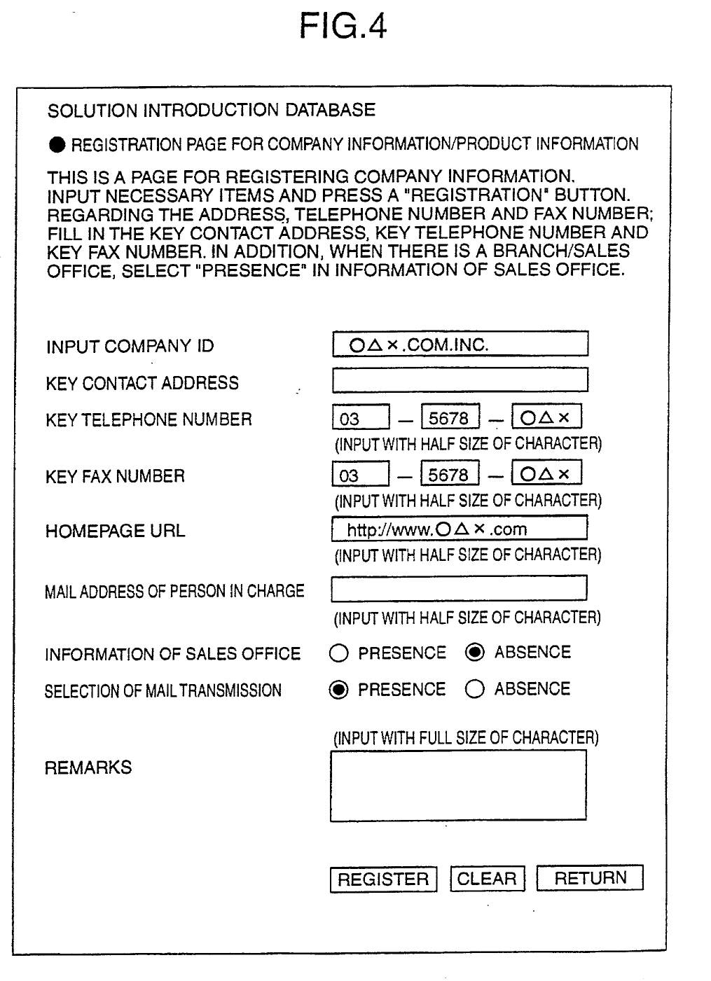

After access is permitted, a screen image illustrated in FIG. 4 is displayed on the output device 24. Company information is inputted by the service supporter in accordance with this screen page. Company information to be inputted includes a plurality of items such as formal “name of company”, “key contact address”, “key telephone number”, “key FAX number”, “homepage URL”, “mail address of person in charge”, “information of sales office”, “selection of mail transmissions”, and “remarks.”

When a registration button at a lower portion of the screen page is clicked by a mouse, inputted information is sent to the server 10 from the service support system 2. Clicking using the mouse is hereinafter described as simply “selection.”

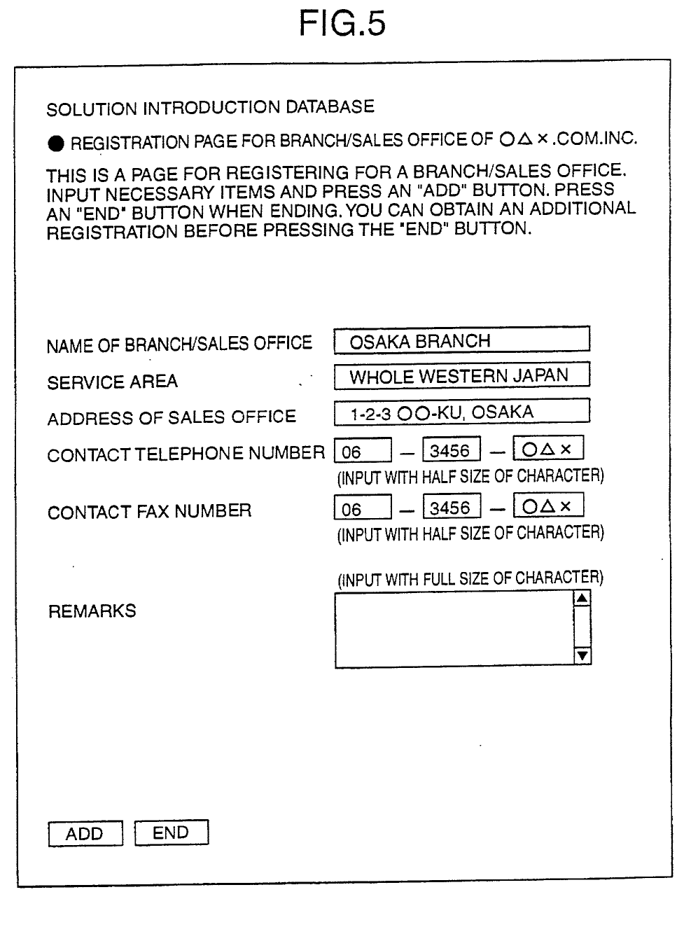

In the item of “information of sales office”, when “presence” is inputted, a screen page as illustrated in FIG. 5 is displayed. In accordance with this screen page, information of branch/sales office is inputted by the service supporter. Information to be inputted includes a plurality of items such as “branch/sales office”, “service area”, “address of sales office”, “contact telephone number”, “contact FAX number”, and “remarks.” In the case where the number of branch/sales offices is two or more, an addition button displayed at the lower left portion is selected to make it possible to input further information.

Company information received by the input device 23 of the service support system 2 is transmitted to the server 10 via the communication control mechanism 21 in accordance with control of the main controller 25.

<Registration Processing A 102>

The communication control mechanism 101 of server 10 sends received company information to the main controller 103. The main controller 103 registers received company information to the storage 102. This completes the registration processing of information relevant to the service supporter.

<Processing for Registering Product Information, Requesting Change or Deletion B102>

The service supporter in which registration of company information has already completed gains access to the server 10 using its ID and PW to make it possible to input product information of the service supporter's AP and change/delete product information already posted. Such processing will be explained as follows:

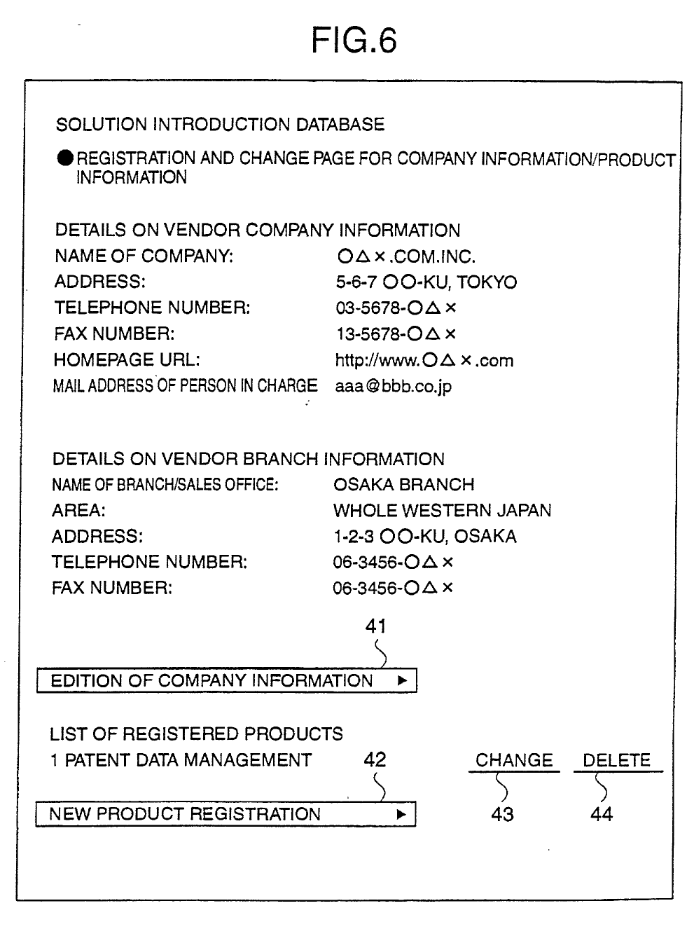

First, the service support system 2 gains access to the server 10 in accordance with the same processing procedure as that of the input B101 of company information done by the service supporter. Screen page information for performing the registration, change, deletion in connection with company information and product information is transmitted from the server 10. The main controller 25 displays information of this screen page on the output device 24. FIG. 6 shows an example of the screen page to be displayed. In the case where registered company information and product information of some AP are already posted on the electronic bulletin board S, a part of this product information is displayed on this screen page as a registered product list.

When an item “company information edition” 41 displayed on the screen page is selected by the service supporter, the main controller 25 sends this selection to the server 10 via the communication control mechanism 21. Though information of screen page for editing company information is sent from the server 10, the screen page to be displayed becomes the same as those of FIG. 4 and FIG. 5. The main processing for editing company information by the service supporter is the same as the aforementioned input B101 of company information, and the explanation is hereinafter omitted. Moreover, though the edition result of company information by the service supporter is sent to the server 10, processing for reflecting the edition result in this server 10 is the same as that of the aforementioned registration processing and the explanation is hereinafter omitted.

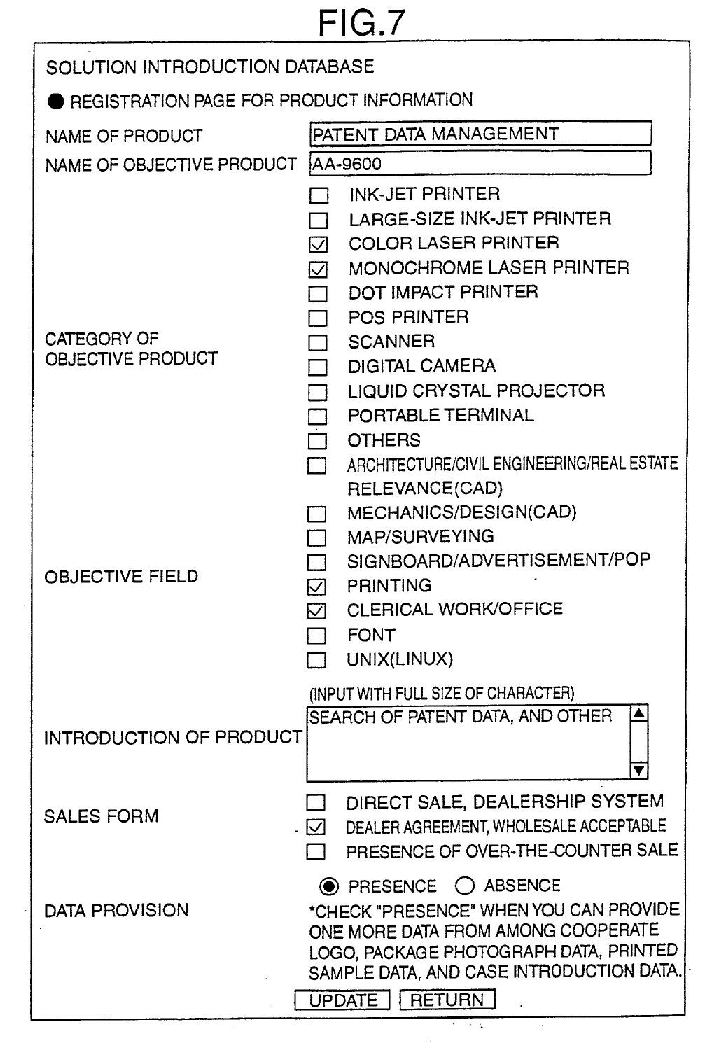

When an item “new product registration” 42 is selected by the service supporter, the main controller 25 sends this selection to the server 10 via the communication control mechanism 21. Information of screen page for editing company information is sent from the server 10. The main controller 25 displays information of the screen page to the output device 24. FIG. 7 shows an example of the screen page to be displayed on the output device 24.

As items to be inputted, a “product name” of a registering product, an “objective product name” that is a product name of ED to which the product is applied, and an “objective product category”, which is the category of this objective product, are described. Moreover, an “introduction of product” where the profile of the product is written, and a “sale form”, which is the form of sales of the product are described as items to be inputted. Still moreover, in the case where it is possible to provide the logo of the service supporter, photograph of the registering product, printed sample data, introduction of case and price list to the contents stored in the storage 22, they can be also registered as input items of “data provision.” It is noted that these inputted items are sent to the service operation system 1 online. The reason is that there is a danger in uploading files whose data kind and size are unclear to the storage 102 indiscriminately. The service operator uploads data received online to an appropriate location of the server 10, and describes a link to data at the time of approving product information. Product information inputted from the input device 23 via the screen page illustrated in FIG. 7 is transmitted to the server 10 by the main controller 25 via the communication control mechanism 21 together with a request for registering product information.

In the case where product information already posted is changed, the service supporter selects a change section 43 displayed to correspond to desired product information from the list of registered products. The main controller 25 notifies the server 10 of the change in the selected product and the selected content via the communication control mechanism 21. Though information of the screen page for changing the selected product information is sent from the server, the screen page to be displayed is the same as that of FIG. 7 for registering product information. Since processing for inputting product information and processing for sending the content are the same as processing for registering product information, the explanation is omitted. In addition, information indicative of selected product information, a request for changing the product information and the changing content are sent to the server 10.

In the case where product information already posted is deleted, the service supporter selects a deletion section 44, which is displayed to correspond to desired information from the list of the registered products. The main controller 25 notifies the server 10 of information indicative of selected product information and a request for deleting this product information via the communication control mechanism 21.

As a result of the aforementioned processing, in the case where product information is registered to the server 10 from the service support system 2, a request for registering product information and the content of the product information are sent thereto. In the case where product information is changed, information that indicates selected product information, a request for changing the product information, and the content to be changed are sent thereto. In the case where product information is deleted, information that indicates selected product information and a request for deleting selected product information are sent thereto.

<Processing for Registering Product Information, Receiving Change or Deletion A103>

An explanation will be given of notification processing of the service operation system 1 in accordance with processing for registering, changing, or deleting product information.

As mentioned above, when processing is carried out in accordance with the operation at the time of registering, changing, or deleting product information in the service support system 2, information and a request according to the processing are sent to the server 10. The main controller 103 of server 10 receives them via the communication control mechanism 101. The main controller 103 temporarily stores received information and request to the storage 102.

In the case where the received request is the change or deletion of product information, product information to be processed is already posted on the electronic bulletin board S. For this reason, the main controller 103 extracts processing product information from the electronic bulletin board S and stores the extracted product information in the storage 102 temporarily, and posts alternative information, which indicates that the product information is being corrected, on the electronic bulletin board S.

After that, the main controller 103 notifies the manager, who should mange processing product information, that information and the request according to the registration of product information, the change, or the deletion are received from the service support system 2. More specifically, processing product information includes information in which at least one of the categories of objective products shown in FIG. 7 is selected. The main controller 103 provides notification to the terminal 11, which is fixed according to this product category and used by the manager, via the LAN 12.

In the case where a plurality of categories of objective products is selected, either of two methods wherein one is that notification is provided to the respective managers and the other is that notification is provided to only one of the managers may be applied. Additionally, in the case were notification is provided to a plurality of managers and the determination of approval does not mach, it is necessary to fix the manager, which finally performs judgment.

Moreover, the above example has been explained on the assumption that the manager, who performs the determination of approval, is fixed by objective product category. However, the present invention is not limited to this. For example, the manager may be fixed in accordance with an “objective field” and a “sales form.”

<Processing for Receiving Determination of Approval A104>

When it is notified of the manager that information and the request according to the registration of product information, the change, or the deletion are received from the service support system 2, the manager 11 operates the terminal 11 in order to perform objective product information in accordance with the content of objective product information and the content of the request for the objective product information. The objective product information is performed based on a given criterion such as whether the content of objective project information is improper, whether objective product information is true or not, whether objective product information is information that slanders the other service supporter and ED, whether objective product information is information that is legally prohibited, and the like.

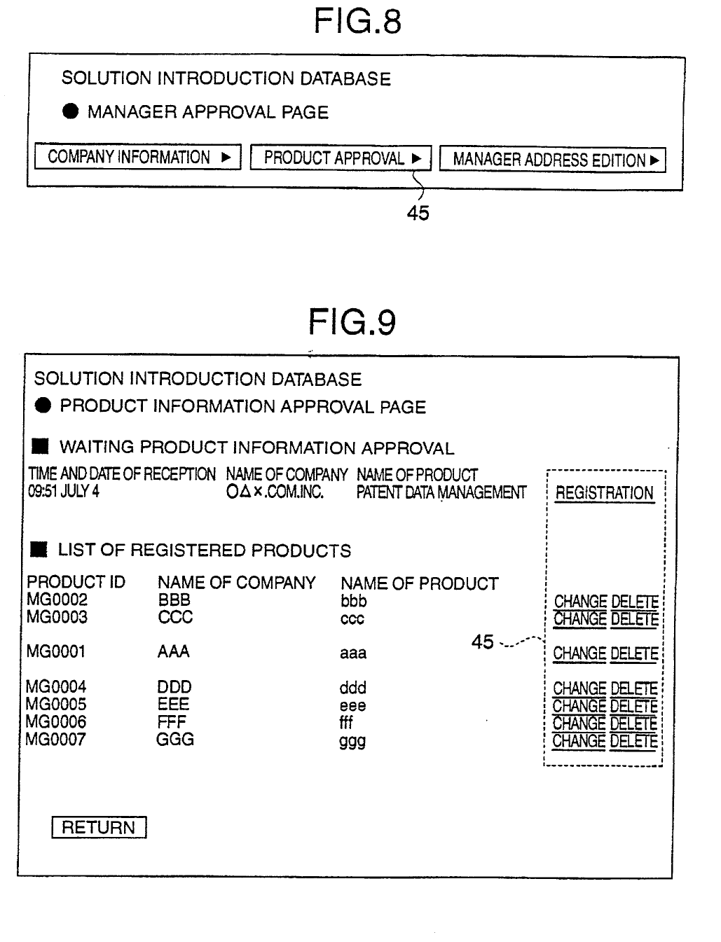

First, the terminal 11 displays a main screen page as illustrated in FIG. 8 when receiving access from the manger. When a central item “product approval” 45 is selected, the terminal 11 notifies the main controller 103 that processing responsive to a request from the service supporter is started. In response to this notification, the main controller 103 causes the terminal 11 to display the list of product information that is in charge of the manager with reference to product information stored in the storage 102. The terminal 11 displays a part of this product information on the screen page as illustrated in FIG. 9. Here, one piece of product information that is a pending approval is already posted on the electronic bulletin board S to indicate that the number of opened product information is 7.

The manager selects product information to be subjected to determination of approval and a content of request with reference to this screen page. More specifically, the manager selects the content (registration, change, or deletion) requested in response to objective product information from a request selector 46 displayed in accordance with product information displayed on the screen page of FIG. 9. The result of selection is sent to the server 10.

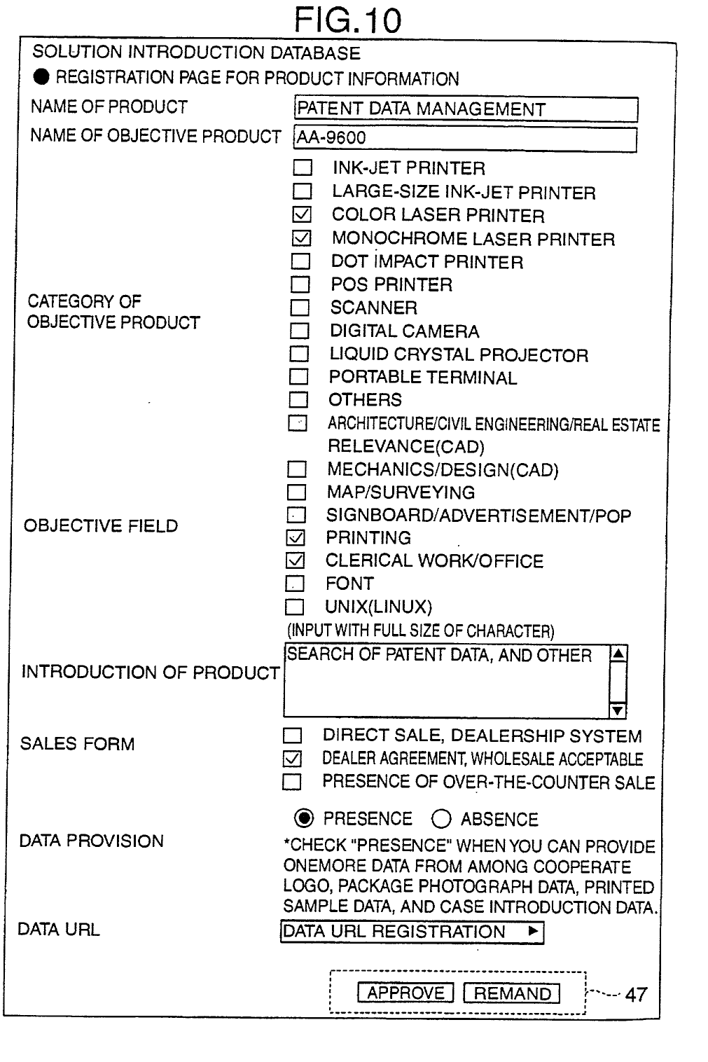

The server 10 sends product information corresponding to the selected context to the terminal 11. For example, regarding “patent data management” that is a pending approval as product information to which the manager provides determination of approval in FIG. 9, “registration”, which is displayed to correspond to “patent data management”, is selected as the content of request. Upon selection of “registration”, the main controller 103 reads product information of “patent data management” stored in the storage 102 and sends it to the terminal 11. The terminal 11 displays the screen page illustrated in FIG. 10.

The manager performs determination of approval with reference to product information displayed on the screen page illustrated in FIG. 10, so that the result can be inputted. The input of determination result is carried out by selecting either of two items, “approve” and “remand” displayed in a determination result input section 47 at the lower portion of FIG. 10. The determination result inputted to the terminal 11 is sent to the server 10 via the LAN 12.

<Processing for Registering, Correcting or Deleting Product Information A105>

The main controller 103 performs processing for registering, changing or deleting the objective product information in accordance with the determination result obtained by the manager.

When the content sent from the service support system 2 is the registration of product information and the registration is approved by the manager (“approve” that is the item of determination result input section 47 is selected), the main controller 103 reads objective product information temporarily stored in the storage 102 and discloses (posts) the read objective product information on the electronic bulletin board S. This makes it possible to browse the objective product information newly registered from the sales shop apparatus 3. When the registration is not approved by the manager (“remand” that is the item of determination result input section 47 is selected), no objective product information is disclosed (posted) on the electronic bulletin board S.

When the content sent from the service support system 2 is the change of product information and the change is approved by the manager, the main controller 103 changes objective product information temporarily stored in the storage 102 and posts the changed objective product information on the electronic bulletin board S. This makes it possible to browse the changed objective product information from the sales shop apparatus 3. When the change is not approved by the manager, objective product information is stored in the storage 102 as it is, and no objective product information is posted on the electronic bulletin board S. For this reason, alternative information is left being posted at the portion of objective product information on the electronic bulletin board S.

When the content sent from the service support system 2 is the deletion of product information and the deletion is approved by the manager, the main controller 103 deletes objective product information temporarily stored in the storage 102 and alternative information posted on the electronic bulletin board S in place of the objective product information. This deletes objective product information posted on the electronic bulletin board S completely. When the deletion is not approved by the manager, objective product information is stored in the storage 102 as it is, and no objective product information is posted on the electronic bulletin board S. For this reason, alternative information is left being posted at the portion of objective product information on the electronic bulletin board S.

After that, the main controller 103 sends the determination result to the service support system 2 using e-mail in any case of the registration of objective product information, the change or the deletion.

<Processing for Receiving Determination Result of Approval B103>

The service support system 2 receives the determination result of approval from the server 10 by e-mail. The main controller 25 displays the received determination result of approval on the output device 24 and printed, and outputted. Or, the main controller 25 may temporarily stores the determination result of approval in the storage 22 and provides notification thereto in accordance with the operation from the service supporter can confirm whether or not the registration of product information, the change or the deletion, which have been performed in B102, is approved

<Browse/Search Processing C10 1>

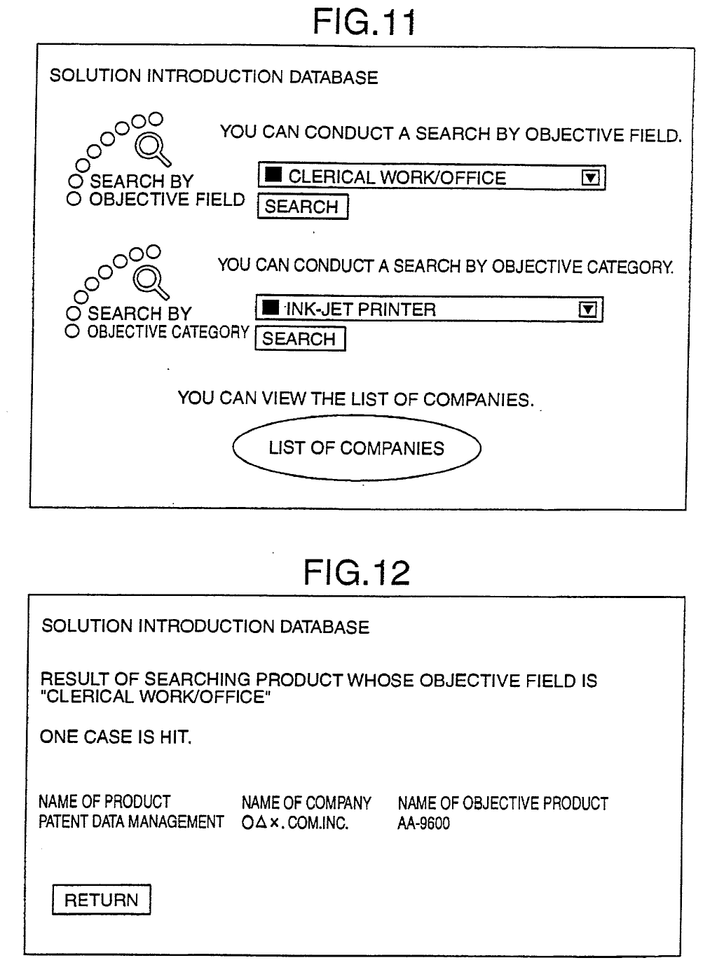

The salesperson gains access to the server 10 via the Internet L using the sales shop apparatus 3, so that the salesperson can browse product information posted on the electronic bulletin board S. In the case of the massive amounts of product information, a search screen page as illustrated in FIG. 11 is displayed on the display device of the sales shop apparatus 3. The sales person inputs information for specifying product information from a desired field or a desired product category via this search screen page. The specified field or category is sent to the server 10 from the sales shop apparatus 3.

The server 10 sends screen information indicative of the search result to the sales shop apparatus 3. The search result as illustrated in FIG. 12 is displayed on the display device. Additionally, search processing at the server 10 is search processing which the main controller 103 provides to the electronic bulletin board S and the general searching technique can be used, so that the explanation is omitted.

At the sales shop apparatus 3, a name of product is specified by the salesperson via the screen page displayed on the display device. The specified name of product is sent to the server 10. In response to this, the server 10 sends product information corresponding to the specified product name and company information of the service supporter dealing with this product to the sales shop apparatus 3.

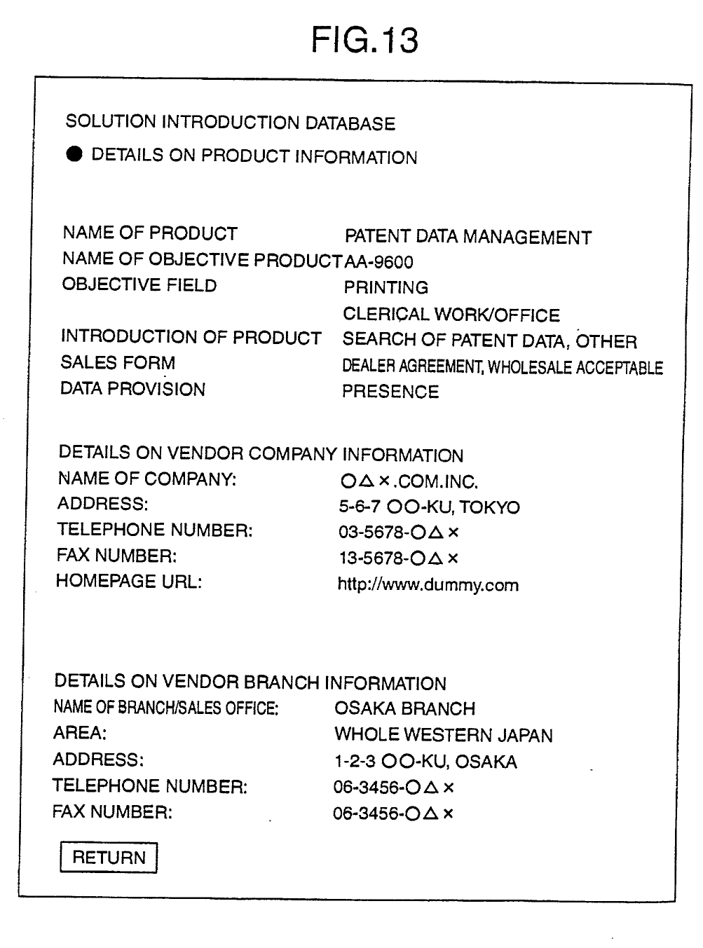

For example, in the case where the product name “patent data management” is specified in FIG. 12, product information of “patent data management” is sent to the sales shop apparatus 3 from the server 10. In connection with this product information, information and company information as illustrated in FIG. 13.

In the case where the specified product information is a pending approval from the manager, alternative information such as “under construction” is displayed as product information. Other than this, in the case where there is another product information that is related to product information that is a pending approval, alternative information for browsing this product information may be displayed.

The salesperson thus browses product information and company information, making it possible to deepen the understanding of ED and AP. This also makes it possible to use information as service to the users who have purchased ED or AA via this salesperson, and to improve service.

As mentioned above, according to this dealership system, the service operator and the service supporter post product information of the other product relevant to a certain product on the electronic bulletin board S and provide information to the sales person in teamwork with each other. Particularly, in this dealership system, the service operator side performs determination of approval at the time of posting product information by the service support. More specifically, at the time of performing the registration of product information, the change, and the deletion, determination of approval is carried out by a given manager. The posting of the product information is limited until the determination is completed. This makes it possible to prevent information from being indiscriminately posted by the service supporter. Accordingly, it is possible to implement useful and sound product information providing service to the salesperson.

As mentioned above, according to the present invention, it is possible to control information providing form on an electronic bulletin board appropriately and efficiently when information relevant to a predetermined subject, for example, information about products is posted on the electronic bulletin board.

Moreover, in each of the service operation system 1, the service support system 2, and the sales shop apparatus 3, the aforementioned core functions can also be implemented by installing the computer program recorded in the recording medium according to the present invention in a household general-purpose computer unit, etc. and allowing the CPU of the general-purpose computer unit to load and execute the computer program.

In the above embodiment, the limitation of the information disclosure is implemented by limiting for information posting on the electronic bulletin board S. However, the limitation of the information disclosure can be implemented by limiting for accessing to information that has been posted on the electronic bulletin board S.

Various embodiments and changes may be made thereunto without departing from the broad spirit and scope of the invention. The above-described embodiment intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

What is claimed is:

1. A method executed in an apparatus to which at least one terminal is capable of accessing via a network, comprising the steps of:
forming an electronic bulletin board for disclosing product information relevant to a product to be readable via said network from a terminal that is operated by a salesperson who sells said product;
receiving a request to register or change said product information, which is sent from a terminal that is operated by a person who wishes to disclose information on said electronic bulletin board via said network; and
limiting the disclosing of product information, which is pursuant to the request, until approval of the received request is obtained from an information manager.

2. The method according to claim 1, wherein said limiting step comprises a substep of replacing an entirety or a part of said requested product information with other information to be disclosed on said electronic bulletin board until approval of the received request is obtained from the information manager.

3. The method according to claim 1, further comprising the step of preregistering introduction information for introducing said person who wishes to disclose information in a preset recording area, and disclosing said introduction information on said electronic bulletin board with product information, which is pursuant to the request, on the precondition that approval is obtained from said information manager.

4. The method according to claim 1, wherein said limiting step comprises a substep of preregistering introduction information for introducing said person who wishes to disclose information in a preset recording area, and disclosing said introduction information on said electronic bulletin board until approval is obtained from the information manager.

5. The method according to claim 1, wherein said request receiving step comprises a substep of informing said person who wishes to disclose information of identifying information for identifying said person, and receiving only the request with said identifying information.

6. The method according to claim 1, further comprising the step of presenting an input screen page for urging registration or change product information to the terminal that is operated by the person who requests the disclosing of information on said electronic bulletin board, whereby constructing an environment in which said person who wishes to disclose information is capable of making said request through said input screen page.

7. The method according to claim 6, wherein said product information is classified into a plurality of groups, and said presenting step comprises a substep of presenting classification items for specifying the information groups on said input screen page, whereby making it possible for said person who wishes to disclose information to select a desired information group through the classification items on the input screen page and to make said request.

8. The method according to claim 7, wherein said information manager is fixed for each classification item,
said request receiving step comprises a substep of, when said request of an arbitrary classification item is made, recognizing the request by the information manager corresponding to the classification item, and
said limiting step comprises a substep of receiving approval or disapproval that said corresponding information manager issues after checking said request.

9. The method according to claim 1, said limiting step comprises a substep of receiving approval or disapproval that said corresponding information manager issues after checking said request, and sending the received approval or disapproval via said network to said terminal that is operated by a person who wishes to disclose information on said electronic bulletin board.

10. A method executed in an apparatus having a logical space to which at least one terminal is capable of accessing via a network, comprising the steps of:
forming an electronic bulletin board for disclosing product information of a predetermined product and/or other products relevant to the predetermined product in said logical space to a salesperson who sells at least one of said predetermined product and other products;
receiving a request to register or change said product information from a terminal that is operated by a person who wishes to disclose information on said electronic bulletin board via said network; and
limiting the disclosing of product information, which is pursuant to the request, until approval of the received request is obtained from an information manager.

11. A method executed in an apparatus having a logical space to which at least one terminal is capable of accessing via a network, comprising the steps of;
forming an electronic bulletin board for disclosing information relevant to a predetermined subject in said logical space to be readable via said network from a terminal that is operated by a user who uses said predetermined subject;
receiving a request to register or change information relevant to said predetermined subject from a terminal that is operated by a person who wishes to disclose information on said electronic bulletin board via said network; and
limiting the disclosing of product information, which is pursuant to the request, until approval of the received request is obtained from an information manager.

12. A system comprising:
means for forming an electronic bulletin board for disclosing information in a logical space to which at least one terminal is capable of accessing via a network;
means for receiving a request to register or change object information from a terminal that is operated by a person who wishes to disclose information on said electronic bulletin board via said network; and
means for limiting the disclosing of object information, which is pursuant to the request, until approval of the received request is obtained from an information manager.

13. The system according to claim 12, wherein said electronic bulletin board includes an area for providing product information relevant to a product to a salesperson who wishes to sell said product, and
said receiving means receives said request to register or change object information relevant to said product.

14. A computer program for rendering a computer to serve as a information disclosing support system connecting with a network, said system comprises:
a function of forming an electronic bulletin board for disclosing information in a logical space to which at least one terminal is capable of accessing via a network;
a function of receiving a request to register or change object information from a terminal that is operated by a person who wishes to disclose information on said electronic bulletin board via said network; and
a function of limiting the disclosing of object information, which is pursuant to the request, until approval of the received request is obtained from an information manager.

15. The computer program according to claim 14, wherein the computer program is stored in a computer readable storage medium.
